(19) United States
(12) Patent Application Publication
(10) Pub. No.: US 2020/0096809 A1
(43) Pub. Date: Mar. 26, 2020

(54) DISPLAY DEVICE

(71) Applicant: Samsung Display Co., Ltd., Yongin-si (KR)

(72) Inventors: Wee-joon JEONG, Seongnam-si (KR); Min-gwan HYUN, Suwon-si (KR); Taegil KANG, Hwaseong-si (KR); Mansoo KIM, Asan-si (KR)

(21) Appl. No.: 16/538,937

(22) Filed: Aug. 13, 2019

(30) Foreign Application Priority Data
Sep. 20, 2018 (KR) 10-2018-0113195

(51) Int. Cl. G02F 1/1333; G02F 1/1335

(52) U.S. Cl. CPC G02F 1/133308; G02F 1/133608; G02F 2001/133314; G02F 1/133606; G02F 1/133603

(57) ABSTRACT

A display device includes a display panel, a bottom chassis disposed facing the display panel; a backlight unit including a light source disposed between the display panel and the bottom chassis; and a reflection module defined by a reflection sheet which has a thickness of about 0.095 millimeter to about 0.15 millimeter and is disposed on a support member having a thickness of about 0.19 millimeter to about 0.21 millimeter, each of the reflection sheet and the support member disposed between the display panel and the bottom chassis.

This application claims priority to Korean Patent Application No. 10-2018-0113195, filed on Sep. 20, 2018, and all the benefits accruing therefrom under 35 U.S.C. § 119, the entire contents of which are hereby incorporated by reference.

### BACKGROUND

### (1) Field

The present disclosure herein relates to a liquid crystal display device, and more particularly, to a liquid crystal display device having a relatively small thickness.

### (2) Description of the Related Art

Display devices are used for displaying an image in various information processing apparatuses such as televisions, monitors, notebooks, mobile phones, and the like. As a display device, a liquid crystal display device includes a liquid crystal display panel including a liquid crystal layer and a backlight unit which provides light to the liquid crystal display panel so as to realize a display device to be driven for a relatively long time or having a relatively large display area.

A liquid crystal display device having a relatively small thickness has been developed so as to provide a display device having improved portability and aesthetics.

### SUMMARY

One or more embodiments provide a display device having a relatively small thickness.

An embodiment provides a display device including a display panel, a backlight unit, a reflection module, and a bottom chassis.

The display panel may include a liquid crystal layer.

The backlight unit is disposed below the display panel and includes a light source.

The reflection module may be disposed below the backlight unit. The reflection module is defined by a reflection sheet which has a thickness of about 0.095 millimeter (mm) to about 0.15 mm and is disposed on a support member having a thickness of about 0.19 mm to about 0.21 mm.

The bottom chassis is disposed below the reflection module.

In an embodiment, the reflection sheet may be disposed between the support member and the backlight unit.

In an embodiment, the reflection sheet may contact the support member.

In an embodiment, the reflection module may be further defined by the reflection sheet on the support member with an adhesion member therebetween.

In an embodiment, the support member may include a metal. In an embodiment, the metal may include stainless steel.

In an embodiment, the reflection sheet may include a polymer material and have reflectance of about 95%.

In an embodiment, the bottom chassis may have a thickness of about 0.285 mm to about 0.315 mm.

In an embodiment, the bottom chassis may have substantially a same thickness as a thickness of the reflection module.

In an embodiment, the bottom chassis may include aluminum or an electro-galvanized steel sheet.

In an embodiment, the display device may further include an adhesion member which couples the bottom chassis and the reflection module to each other.

In an embodiment, a first opening may be defined in the bottom chassis, and a second opening corresponding to the first opening may be defined in the reflection module.

In an embodiment, the display device may further include a same one fixing member which is extendable into the first opening and the second opening to couple the bottom chassis and the reflection module to each other.

In an embodiment, the backlight unit may further include a light guide member which guides light received from the light source to the display panel.

In an embodiment, the light guide member may contact the reflection sheet.

In an embodiment, a display device includes a display panel, a backlight unit, a reflection module, and a bottom chassis.

The backlight unit is disposed under the display panel. The backlight unit may include a light source and a light guide member which guides light received from the light source to the display panel.

The reflection module is defined by a reflection sheet which has a thickness of about 0.095 mm to about 0.15 mm and is disposed on a support member having a thickness of about 0.19 mm to about 0.21 mm, and the reflection sheet may contact the light guide member.

The bottom chassis is disposed below the reflection module and has a thickness of about 0.285 mm to about 0.315 mm.

### BRIEF DESCRIPTION OF THE DRAWINGS

The accompanying drawings are included to provide a further understanding of the invention, and are incorporated in and constitute a part of this disclosure. The drawings illustrate exemplary embodiments of the invention and, together with the description, serve to explain principles of the invention. In the drawings:

FIG. 1 is a perspective view of an embodiment of a display device;

FIG. 2 is an exploded perspective view of an embodiment of a display device;

FIG. 3 is a block diagram of an embodiment of a display device;

FIG. 4 is an equivalent circuit diagram of an embodiment of a pixel of a display device;

FIG. 5 is a cross-sectional view of an embodiment of a pixel of a display device;

FIGS. 6A and 6B are cross-sectional views of embodiments of reflection modules and a corresponding bottom chassis, respectively;

FIG. 7 is a cross-sectional view of another embodiment of a reflection module;

FIGS. 8 and 9 are respectively exploded perspective views of other embodiments of a display device; and

FIG. 10 is a perspective view of still another embodiment of a display device.

### DETAILED DESCRIPTION

Hereinafter, exemplary embodiments of the invention will be described with reference to the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein

In the figures, the ratio and dimensions of components are exaggerated for clarity of illustration. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” The term “and/or” includes any and all combinations of one or more of the associated listed items.

The meaning of ‘include’ or ‘comprise’ specifies a property, a fixed number, a step, an operation, an element, a component or a combination thereof, but does not exclude other properties, fixed numbers, steps, operations, elements, components or combinations thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

To reduce an overall thickness of a display device such as a liquid crystal display device, a thickness of a bottom chassis and/or a reflection sheet within the display device may be reduced. However, when the bottom chassis is reduced in thickness, a strength of the bottom chassis may be weakened to deteriorate heat dissipation characteristics of the bottom chassis within the display device. Also, when the reflection sheet is reduced in thickness, the reflection sheet may be relatively easily damaged in a process of assembling the display device.

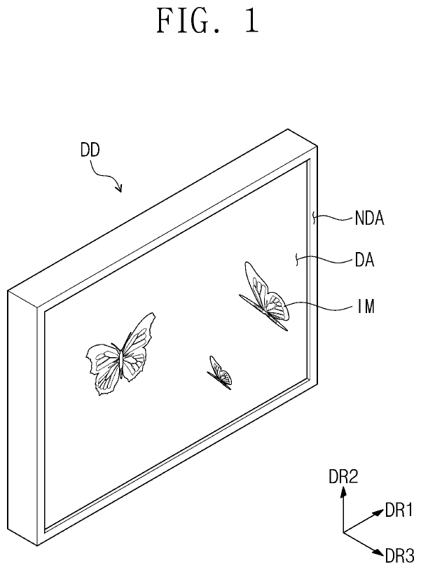

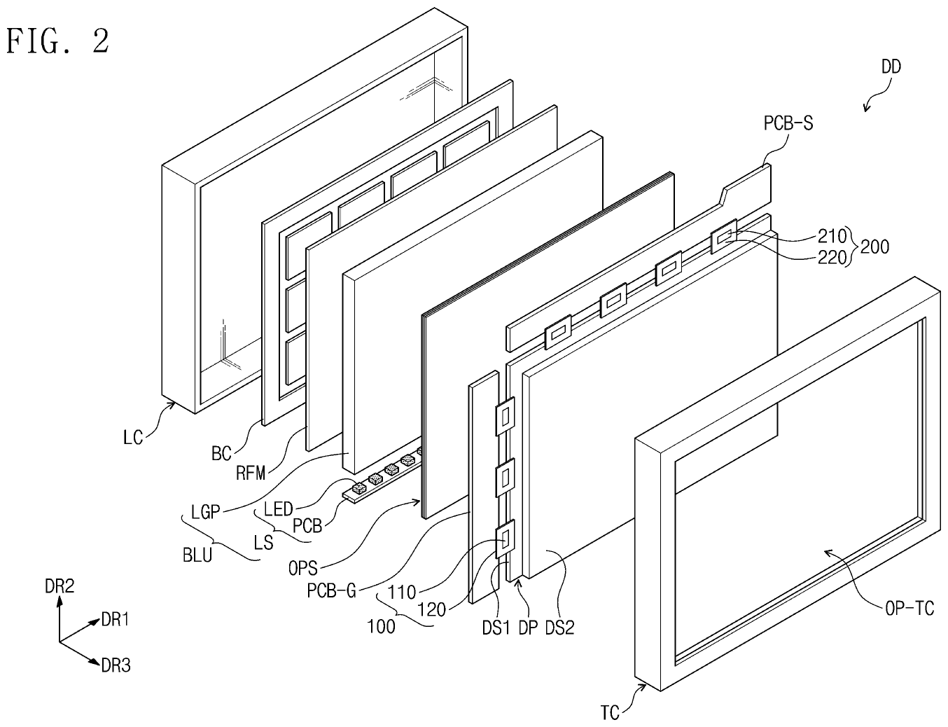

FIG. 1 is a perspective view of an embodiment of a display device DD. FIG. 2 is an exploded perspective view of the display device DD.

Referring to FIGS. 1 and 2, a display device DD may include a top cover TC, a display panel DP, a gate driving circuit 100, a data driving circuit 200, an optical member OPS, a backlight unit BLU, a reflection module RFM, a bottom chassis BC, and a bottom cover LC.

As illustrated in FIG. 1, the display device DD includes a display area DA and a non-display area NDA. The display area DA is disposed in a plane that is parallel to a plane defined by a first direction DR1 and a second direction DR2 which crosses the first direction DR1. The first direction DR1 may be perpendicular to the second direction DR2, without being limited thereto. A thickness of the display device DD and components thereof may be defined along a third direction DR3 which crosses each of the first direction DR1 and the second direction DR2.

The non-display area NDA may be defined by a planar area in the plane defined by the first direction DR1 and the second direction DR2 and corresponding to the top cover TC. When the display device DD excludes the top cover TC, the non-display area NDA may be defined by a sealing member or a mold of the display device DD.

The display area DA provides information of an image IM to outside the display device DD. In FIG. 1, a butterfly is illustrated as an example of the image IM. That is, the image IM is displayed at the display area DA, while the image IM is not displayed at the non-display area NDA.

The top cover TC may form an outermost surface of the display device DD and protect the display panel DP and other components of the display device DD against an external impact or contaminants incident thereto. An opening OP-TC of the top cover TC may expose a front surface of the display panel DP to define the display area DA. The components which form the display device DD may each have a display area DA and a non-display area NDA corresponding to those of the display device DD.

The display panel DP may be disposed below the top cover TC in a direction opposite to the third direction DR3. Particularly, the display panel DP may be disposed between the top cover TC and the optical member OPS.

The display panel DP displays an image. The display panel DP is not specifically limited. That is, the display panel DP may include a non-emission type display panel for which a separate light source is provided within the display device DD, e.g., a reflective/transmissive display panel or a transmissive display panel. Hereinafter, a liquid crystal display panel will be described as an example of the display panel DP.

The display panel DP may include a first substrate DS1, a second substrate DS2 facing the first substrate DS1, and an optical control layer such as a liquid crystal layer LCL (see FIG. 5) disposed between the first substrate DS1 and the second substrate DS2. The liquid crystal layer LCL may include a plurality of liquid crystal molecules that change in arrangement according to electric fields formed between the first substrate DS1 and the second substrate DS2. Each of the first substrate DS1 and the second substrate DS2 may include glass. For convenience of illustration, FIG. 2 generally shows the first substrate DS1 and the second substrate DS2 of the display panel DP. However, it will be understood that the first substrate DS1 and the second substrate DS2 may respectively represent base substrates within a first display substrate and a second display substrate in which various layers, elements, etc. are provided on the base substrates.

Although not shown, a polarizing plate may be disposed above and below the display panel DP, along the third direction DR3. In FIGS. 1 and 2, although the display panel DP has a planar shape, the invention is not limited thereto. In an embodiment, for example, a display panel may be provided to have a predetermined curvature.

The optical member OPS may be disposed below the display panel DP. Particularly, the optical member OPS may be disposed between the display panel DP and the backlight unit BLU.

The optical member OPS may include at least one of a diffusion plate, a diffuser, a first prism sheet (or a horizontal prism sheet), a second prism sheet (or a vertical prism sheet) and a brightness enhancement member.

The diffusion plate diffuses light incident from a light source LS toward the display panel DP. Thus, the light emitted from the light source LS may be improved in uniformity in distribution thereof. The diffuser diffuses incident light to provide the diffused light to the display panel DP. The diffuser may be provided in a sheet shape, unlike the diffusion plate. The first prism sheet changes a traveling direction of the incident light into the first direction DR1. In an embodiment, for example, if the first prism sheet is the horizontal prism sheet, the traveling direction of the light may be changed into a horizontal direction (e.g., along the plane defined by the first direction DR1 and the second direction DR2).

The second prism sheet changes a traveling direction of the incident light into the second direction DR2 which may be perpendicular to the first direction DR1. In an embodiment, for example, if the second prism sheet is the vertical prism sheet, the traveling direction of the light may be changed into a vertical direction (e.g., along the third direction DR3).

However, the kind of optical member OPS is not limited thereto. That is, the optical member OPS may be a sheet for changing or improving characteristics of the incident light.

The backlight unit BLU may be disposed below the optical member OPS. Particularly, the backlight unit BLU may be disposed between the optical member OPS and the reflection module RFM.

The backlight unit BLU may generate and provide light to the display panel DP.

In an embodiment, the backlight unit BLU may include a light guide member LGP and the light source LS.

The light guide member LGP guides generated light received from the light source LS to emit the light toward the display panel DP. The light guide member LGP may have a transparent property.

The light source LS may include a point light source LED provided in plurality and a printed circuit board PCB.

The point light source LED may include a light emitting diode chip. The a light emitting diode chip may be mounted on the printed circuit board PCB and emit light in a visible light region among regions along the light spectrum.

The reflection module RFM may be disposed below the backlight unit BLU. Particularly, the reflection module RFM may be disposed between the backlight unit BLU and the bottom chassis BC.

The reflection module RFM reflects light emitted from the backlight unit BLU.

In an embodiment, the reflection module RFM may contact the light guide member LGP. However, the invention is not limited thereto. In an embodiment, for example, the reflection module RFM may be spaced apart from the light guide member LGP along the third direction DR3.

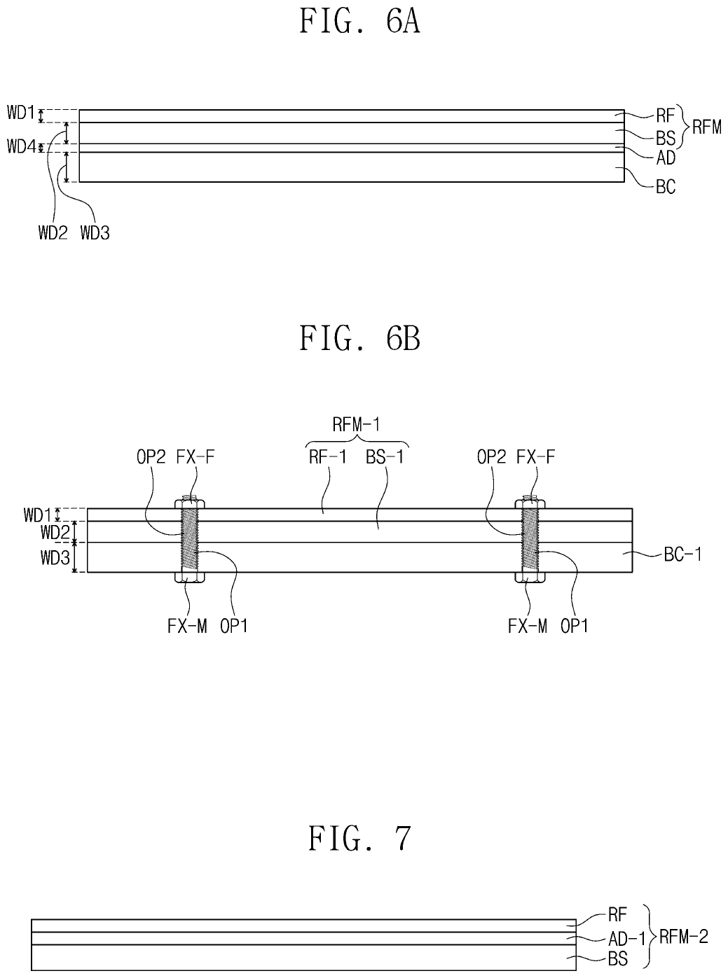

The reflection member RFM will be described in more detail with reference to FIGS. 6A, 6B, and 7.

In FIG. 2, the backlight unit BLU may be an edge-type backlight unit, but is not limited thereto. In another embodiment, the backlight unit BLU may be a direct-type backlight unit.

The bottom chassis BC may be disposed below the reflection module RFM and faces the display panel DP. Particularly, the bottom chassis BC may be disposed between the reflection module RFM and the bottom cover LC.

The bottom chassis BC may support therein the display panel DP, the backlight unit BLU and/or the reflection module RFM.

In an embodiment, the bottom chassis BC may be a metal material. In an embodiment of providing the display device DD, a metal material may be processed through a sheet metal molding operation to provide the bottom chassis BC.

The bottom cover LC may be disposed below the bottom chassis BC. The bottom cover LC may form an outermost surface of the display device DD and protect the display device DD against an external impact or containments incident thereto.

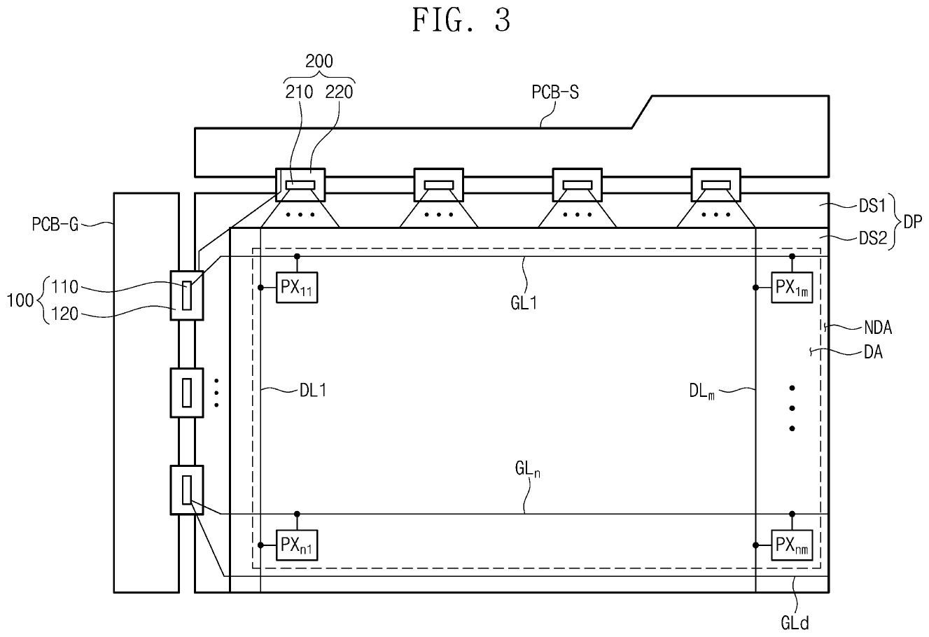

FIG. 3 is a block diagram of an embodiment of the display device DD of FIG. 1.

The display panel DP includes a display area DA in which a plurality of pixels PX₁₁ to PXₙₘ are disposed and a non-display area NDA which is adjacent to the display area DA such as surrounding the display area DA.

The display panel DP includes a plurality of gate lines GL1 to GLn and a plurality of data lines DL1 to DLm which crosses the gate lines GL1 to GLn. The plurality of gate lines GL1 to GLn and the plurality of data lines DL1 to DLm are provided on the first substrate DS1 as a base substrate of a first display substrate of the display panel DP. The plurality of gate lines GL1 to GLn are connected to the gate driving circuit 100. The plurality of data lines DL1 to DLm are connected to the data driving circuit 200. FIG. 3 illustrates only a portion of the plurality of gate lines GL1 to GLn and only a portion of the plurality of data lines DL1 to DLm. Also, the display panel DP may further include a dummy gate line GLd.

FIG. 3 illustrates only a portion of the plurality of pixels PX₁₁ to PXₙₘ. The plurality of pixels PX₁₁ to PXₙₘ are connected to corresponding gate lines of the plurality of gate lines GL1 to GLn and corresponding data lines of the plurality of data lines DL1 to DLm, respectively. However, the dummy gate line GLd may not be connected to the plurality of pixels PX₁₁ to PXₙₘ.

The plurality of pixels PX₁₁ to PXₙₘ may be classified into a plurality of groups according to displayed colors. The plurality of pixels PX₁₁ to PXₙₘ may respectively display one among primary colors. The primary colors may include red, green, blue, and white colors. However, the invention is not limited thereto. In an embodiment, for example, the primary colors may include various colors such as a yellow color, cyan, and magenta.

The gate driving circuit 100 and the data driving circuit 200 may receive a control signal from a signal control unit (e.g., a timing controller, not shown). The gate driving circuit 100 may include a first driving chip 110 and a first flexible circuit board 120. The data driving circuit 200 may include a second driving chip 210 and a second flexible circuit board 220.

The signal control unit may be mounted on a source circuit board PCB-S. The signal control unit receives image data and a control signal from an external graphic control unit (not shown) which is external to the display panel DP. The control signal may include a vertical synchronization signal that is a signal for discriminating frame periods of time, a horizontal synchronization signal that is a signal for discriminating horizontal periods of time, e.g., a row discrimination signal, a data enable signal having a relatively high level during only a period of time for which data is outputted to display a data input period, and a clock signal.

The gate driving circuit 100 generates gate signals on the basis of the control signal (hereinafter, a gate control signal) received from the signal control unit during the frame periods to output the gate signals to the gate lines GL1 to GLn. The gate signals may sequentially output to correspond to the horizontal periods of time.

FIG. 3 illustrates an example of a single one of the gate driving circuit 100 connected to left ends of the plurality of gate lines GL1 to GLn. In an embodiment, although the gate driving circuit 100 of the tape carrier package-type (“TCP-type”) gate driving circuit 100 by a gate circuit board PCB-G is exemplarily illustrated, the invention is not limited thereto. In another embodiment, the gate driving circuit 100 may be provided on a base substrate of the display panel DP by being simultaneously provided or formed together with layers and elements of the pixels PX₁₁ to PXₙₘ of the display area DA, such as through a thin film process. In an embodiment, for example, the gate driving circuit 100 may be provided on the base substrate of the display panel DP in the form of an amorphous silicon thin film transistor (“TFT”) gate driver circuit (“ASG”) or oxide semiconductor TFT gate driver circuit (“OSG”), in the non-display area NDA.

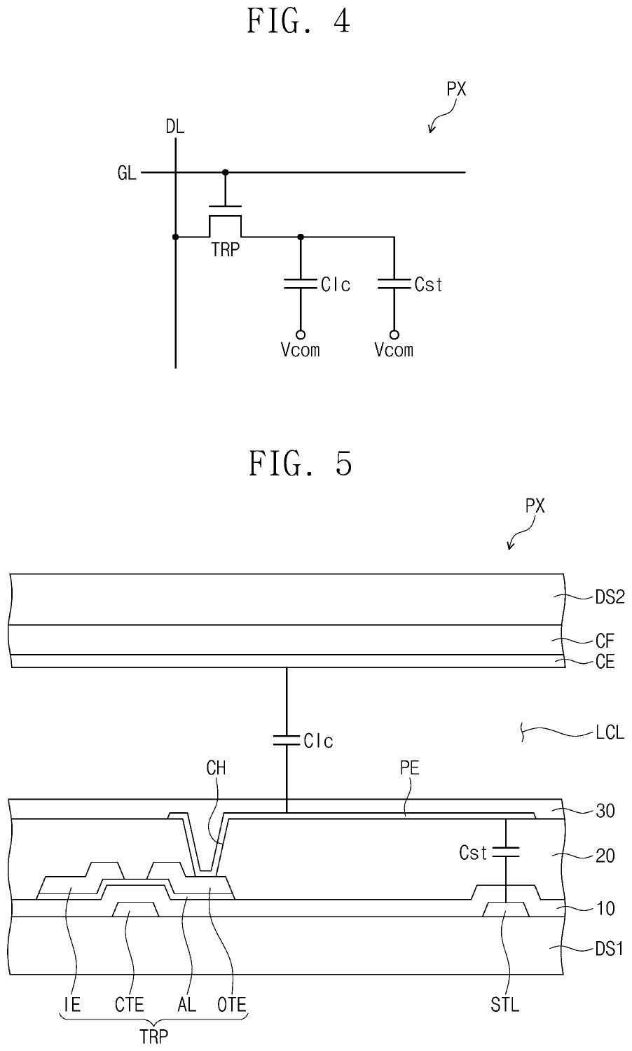

FIG. 4 is an equivalent circuit diagram of an embodiment of a pixel PX of a display device. FIG. 5 is a cross-sectional view of the pixel PX.

Referring to FIG. 4, a pixel PX includes a pixel thin film transistor TRP (hereinafter, referred to as a pixel transistor), a liquid crystal capacitor Clc, and a storage capacitor Cst.

Hereinafter, the transistor in this disclosure may represent a thin film transistor. In an embodiment, the storage capacitor Cst may be omitted.

In FIGS. 4 and 5, the pixel transistor TRP electrically connected to a gate line GL and a data line DL is exemplarily illustrated.

The pixel transistor TRP outputs a pixel voltage corresponding to a data signal received from the data line DL in response to a gate signal received from the gate line GL.

The liquid crystal capacitor Clc is charged with the pixel voltage outputted from the pixel transistor TRP. Liquid crystal directors contained in the liquid crystal layer LCL (see FIG. 5) may be changed in arrangement according to an amount of electric charges charged in the liquid crystal capacitor Clc. As the liquid crystal directors are arranged, light incident into an optical control layer such as the liquid crystal layer LCL may be transmitted or blocked thereby.

The storage capacitor Cst is connected in parallel to the liquid crystal capacitor Clc. The storage capacitor Cst may maintain the arrangement of the liquid crystal directors during a predetermined period of time.

As illustrated in FIG. 5, the pixel transistor TRP on the first substrate DS1 (as a base substrate of a first display substrate) includes a control electrode CTE connected to the gate line GL, an activation layer AL overlapping the control electrode CTE, an input electrode IE connected to the data line DL, and an output electrode OTE disposed to be spaced apart from the input electrode IE.

The liquid crystal capacitor Clc includes a pixel electrode PE and a common electrode CE which is on the second substrate DS2 (as a base substrate of a second display substrate). The storage capacitor Cst includes the pixel electrode PE and a portion of a storage line STL which overlaps the pixel electrode PE. A common voltage Vcom is applied to the common electrode CE, and a data signal is applied to the pixel electrode PE.

The gate line GL and the storage line STL are disposed on the first substrate DS1, to be in a same layer of the first display substrate among those layers provided on the first substrate DS1. The gate line GL extends to define a branch thereof as the control electrode CTE. The gate line GL and the storage line STL may include or be formed of a metal such as Al, Ag, Cu, Mo, Cr, Ta, and Ti, or an alloy thereof. The gate line GL and the storage line STL may respectively include a multi-layered structure, e.g., a Ti layer and a Cu layer.

A first insulation layer 10 covering the control electrode CTE and the storage line STL is disposed on the first substrate DS1. The first insulation layer 10 may include at least one of an inorganic material and an organic material. The first insulation layer 10 may include a multi-layered structure, for example, a silicon nitride layer and a silicon oxide layer.

The activation layer AL overlapping the control electrode CTE is disposed on the first insulation layer 10. The activation layer AL may include a semiconductor layer (not shown) and an ohmic contact layer (not shown).

The activation layer AL may include an amorphous silicon or a polysilicon. Also, the activation layer AL may include a metal oxide semiconductor.

The output electrode OTE and the input electrode IE are disposed on the activation layer AL. The output electrode OTE and the input electrode IE are disposed to be spaced apart from each other. Each of the output electrode OTE and the input electrode IE may partially overlap the control electrode CTE.

Although the pixel transistor TRP having a staggered structure is illustrated as an example in FIG. 5, the structure of the pixel transistor TRP is not limited thereto. The pixel transistor TRP may have a planar structure.

A second insulation layer 20 covering the activation layer AL, the output electrode OTE, and the input electrode IE is disposed on the first insulation layer 10. The second insulation layer 20 provides a planar surface which is flat. The second insulation layer 20 may include an organic material.

The pixel electrode PE is disposed on the second insulation layer 20. The pixel electrode PE is connected to the output electrode OTE through the second insulation layer 20, at a contact hole CH which extends through the second insulation layer 20. An alignment layer 30 covering the pixel electrode PE may be disposed on the second insulation layer 20.

A color filter layer CF is disposed on the second substrate DS2. The common electrode CE is disposed the color filter layer CF. A common voltage is applied to the common electrode CE. The common voltage and the pixel voltage may have values different from each other. An alignment layer (not shown) covering the common electrode CE may be disposed on the common electrode CE. An insulation layer (not shown) may be disposed between the color filter layer CF and the common electrode CE within the second display substrate.

The pixel electrode PE and the common electrode CE disposed with the liquid crystal layer LCL therebetween may form the liquid crystal capacitor Clc. Also, a portion of the pixel electrode PE and the storage line STL, which are disposed with the first insulation layer 10 and the second insulation layer 20 therebetween, may form the storage capacitor Cst. The storage line STL receives a storage voltage having a value different from that of the pixel voltage. The storage voltage may have the same value as the common voltage.

The cross-section of the pixel PX of FIG. 5 may be merely one example. Unlike the structure of FIG. 5, at least one of the color filter layer CF and the common electrode CE may be disposed within the first display substrate on the first substrate DS1 as a base substrate of the first display substrate. That is, a display panel according to another embodiment may include pixels such as a vertical alignment (“VA”) mode pixel, a patterned vertical alignment (“PVA”) mode pixel, an in-plane switching (“IPS”) mode pixel, a fringe-field switching (“FFS”) mode pixel, and a plane to line switching (“PLS”) mode pixel.

FIGS. 6A and 6B are cross-sectional views of embodiments of a reflection module RFM and a reflection module RFM-1, and embodiments of a corresponding bottom chassis BC and bottom chassis BC-1, respectively.

Referring to FIG. 6A, the reflection module RFM may include a reflection sheet RF and a support member BS. The reflection module RFM may be defined by the reflection sheet RF disposed on the support member BS.

The reflection sheet RF may be a component for reflecting light emitted from the backlight unit BLU and may have reflectance of about 95%. The reflection sheet RF may include a polymer material and be directly disposed on the support member BS through a method such as coating.

The support member BS may secure overall rigidity of the reflection module RFM and have a rigid property.

The support member BS may include a metal material. Particularly, the support member BS may include stainless steel. When the support member BS includes stainless steel, the reflection module RFM may have a superior heat dissipation characteristics while and rigidity.

However, the invention is not limited thereto. In an embodiment, for example, the support member BS may include aluminum (Al) or electro-galvanized steel sheet (“SECC”). When the support member BS includes aluminum (Al), the manufacturing costs may increase, but the heat dissipation characteristics may be improved. When the support member BS includes electro-galvanized steel sheet (“SECC”), the heat dissipation characteristics may be decreased, but the manufacturing costs may be reduced.

The bottom chassis BC may include aluminum (Al) or electro-galvanized steel sheet (“SECC”). When the bottom chassis BC includes aluminum (Al), the manufacturing costs may increase, but the heat dissipation characteristics may be improved. When the bottom chassis BC includes electro-galvanized steel sheet (“SECC”), the heat dissipation characteristics may be decreased, but the manufacturing costs may be reduced.

In an embodiment, the reflection module RFM and the bottom chassis BC may be coupled to each other by an adhesion member AD. The adhesion member AD may be a pressure sensitive adhesive (“PSA”).

The reflection sheet RF may have a first thickness WD1 along the third direction DR3. The first thickness WD1 may be about 0.095 millimeter (mm) to about 0.15 mm. That is, the first thickness WD1 may have a tolerance within about 5% of about 0.1 mm. When the first thickness WD1 has a thickness less than about 0.095 mm, the thickness of the reflection sheet RF is too small, and thus, the reflection sheet RF may be damaged during the manufacturing process. When the first thickness WD1 exceeds about 0.15 mm, the thickness of the reflection sheet RF is too large, and providing a display device DD which is relatively thin may be difficult.

The support member BS may have a second thickness WD2 along the third direction DR3. The second thickness WD2 may be about 0.19 mm to about 0.21 mm. That is, the second thickness WD1 may have a tolerance within about 5% of about 0.2 mm. When the second thickness WD2 is less than about 0.19 mm, the overall rigidity of the support member BS may be weakened. When the second thickness WD2 exceeds about 0.21 mm, the thickness of the support member BS is too large, and providing a display device DD which is relatively thin may be difficult.

The bottom chassis BC may have a third thickness WD3 along the third direction DR3. The third thickness WD3 may be about 0.285 mm to about 0.315 mm. That is, the third thickness WD3 may have a tolerance within about 5% of about 0.3 mm. When the third thickness WD3 is less than about 0.285 mm, the overall rigidity of the bottom chassis BC may be weakened. When the third thickness WD3 exceeds about 0.315 mm, the thickness of the bottom chassis BC is too large, and providing a display device DD which is relatively thin may be difficult.

The adhesion member AD may have a fourth thickness WD4 along the third direction DR3. The fourth thickness WD4 may be about 0.095 mm to about 0.15 mm. That is, the fourth thickness WD4 may have a tolerance within about 5% of about 0.1 mm. When the fourth thickness WD4 has a thickness less than about 0.095 mm, the thickness of the adhesion member AD is too small, and thus, providing sufficient adhesion of the adhesion member AD may be difficult. When the fourth thickness WD4 exceeds about 0.15 mm, the thickness of the adhesion member is too large, and providing a display device DD which is relatively thin may be difficult.

In an embodiment, the thickness of the reflection module RFM and the thickness of the bottom chassis BC may be substantially the same, e.g., may be equal to or the same as each other. That is, the sum of the first thickness WD1 and the second thickness WD2 may be substantially the same as the third thickness WD3. Thus, when an assembly of the reflection module RFM and the bottom chassis BC is bent at a predetermined curvature, a neutral plane of the assembly may be formed in or at the adhesion member AD. Thus, damage to the reflection module RFM and the bottom chassis BC by external force, such as in bending the assembly thereof, may be reduced or effectively prevented.

Referring to FIG. 6B, a coupling method between a reflection module RFM-1 and a bottom chassis BC-1 is different from that illustrated in FIG. 6A. Particularly, as illustrated in FIG. 6B, the reflection module RFM-1 and the bottom chassis BC-1 may be coupled to each other by using fixing members such as first fixing member FX-M and as second fixing member FX-F instead of the adhesion member AD of FIG. 6A.

A first opening OP1 may be defined in the bottom chassis BC-1, and a second opening OP2 which corresponds to the first opening OP1 may be defined in the reflection module RFM-1. A same one of the first fixing member FX-M is extendable into both the first opening OP1 and the second opening OP2 to couple the bottom chassis BC and the reflection module RFM-1 to each other.

A same one of the first fixing member FX-M may be extended into the first opening OP1 and the second opening OP2 and then coupled to the second fixing member FX-F. As described above, the reflection module RFM-1 and the bottom chassis BC-1 may be coupled to each other by the first fixing member FX-M and the second fixing member FX-F.

FIG. 7 is a cross-sectional view of another embodiment of a reflection module RFM-2. The reflection module RFM-2 may include a reflection sheet RF, a support member BS, and an adhesion member AD-1. The adhesion member AD-1 may be a pressure sensitive adhesive (“PSA”).

Unlike the above-described reflection modules RFM and RFM-1, in the reflection module RFM-2 of FIG. 7, the reflection sheet RF and the support member BS may be coupled to each other by the adhesion member AD-1. The reflection module RFM-2 may be defined by the reflection sheet RF disposed on the support member BS with the adhesion member AD-1 disposed therebetween

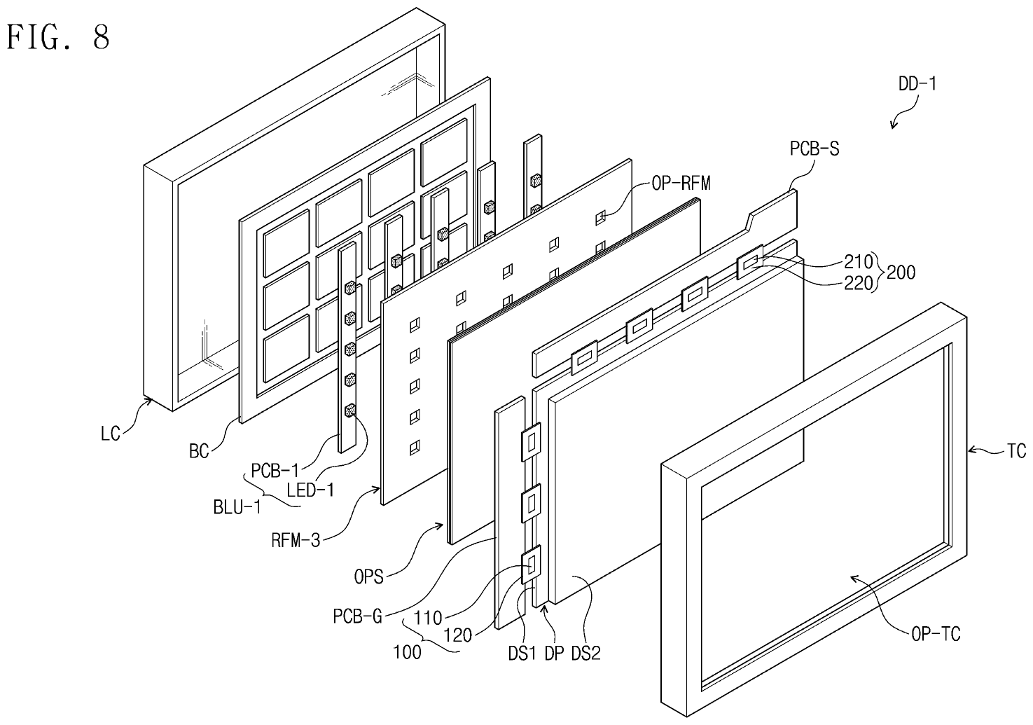

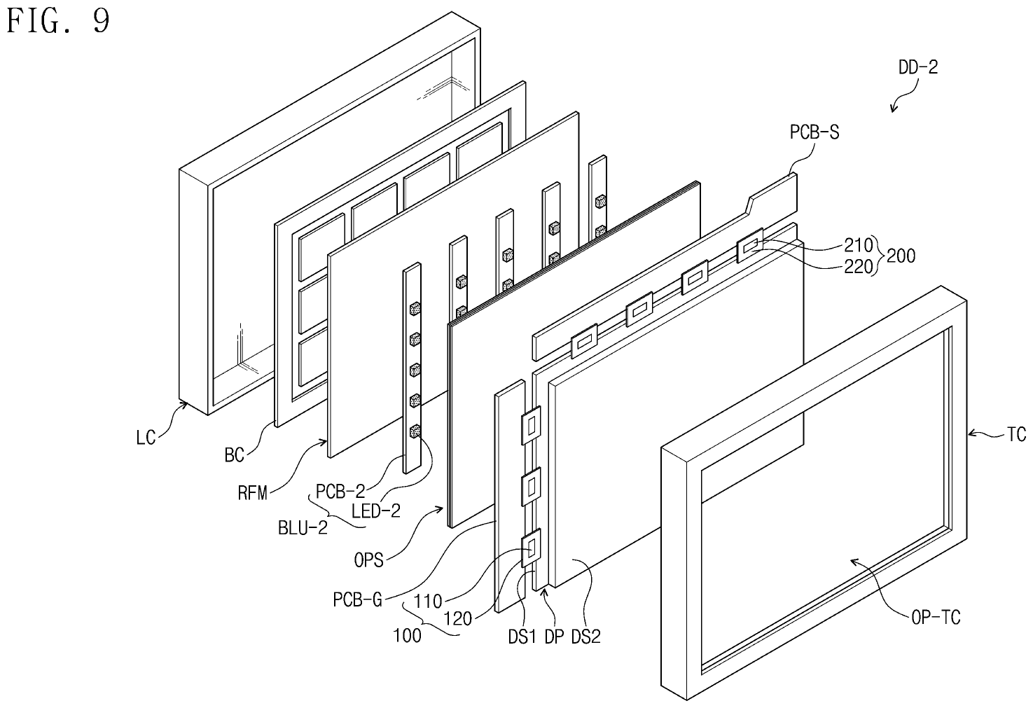

FIGS. 8 and 9 are respectively exploded perspective views of other embodiments of display devices DD-1 and DD-2. Unlike the display device DD of FIG, 2, the display device DD-1 and the display device DD-2 of FIGS. 8 and 9 may include a direct-type backlight unit BLU-1 and a direct-type backlight unit BLU-2, respectively.

Referring to FIG. 8, the backlight unit BLU-1 may include a point light source LED-1 and a printed circuit board PCB-1. More than one of an opening OP-RFM may be defined in a reflection module RFM-3.

More than one of the point light source LED-1 may be provided on a same one of the printed circuit board PCB-1. Each one of the point light source LED-1 may be extended into an opening OP-RFM defined in the reflection module RFM-3.

Referring to FIG. 9, the backlight unit BLU-2 may be disposed between the reflection module RFM and the optical member OPS.

Descriptions with respect to other components are substantially the same as those of the components of FIGS. 1 to 2 and thus will be omitted.

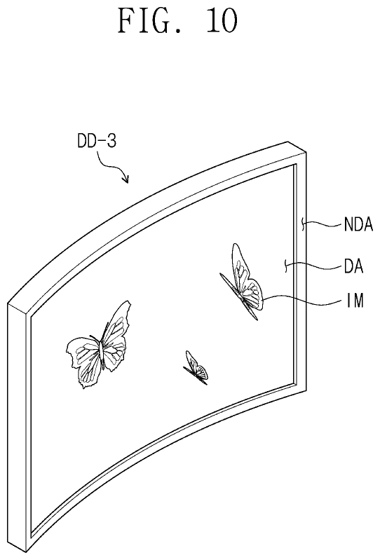

FIG. 10 is a perspective view of still another embodiment of a display device DD-3. As illustrated in FIG. 10, the display device DD-3 may be a curved display device having a predetermined curvature.

According to one or more embodiment, a display device having a relatively small thickness while having overall rigidity may be provided.

Also, according to one or more embodiment, a display device having a relatively small thickness while having improved heat dissipation characteristics may be provided.

It will be apparent to those skilled in the art that various modifications and variations can be made to the above-described embodiments. Thus, it is intended that the present disclosure covers the modifications and variations of this invention provided they come within the scope of the appended claims and their equivalents. Thus, to the maximum extent allowed by law, the scope of the invention is to be determined by the broadest permissible interpretation of the following claims and their equivalents, and shall not be restricted or limited by the foregoing detailed description.

What is claimed is:

1. A display device comprising:
a display panel;
a bottom chassis disposed facing the display panel;
a backlight unit comprising a light source disposed between the display panel and the bottom chassis; and
a reflection module defined by a reflection sheet which has a thickness of about 0.095 millimeter to about 0.15 millimeter and is disposed on a support member having a thickness of about 0.19 millimeter to about 0.21 millimeter, each of the reflection sheet and the support member disposed between the display panel and the bottom chassis.

2. The display device of claim 1, wherein the reflection sheet is disposed between the support member and the backlight unit.

3. The display device of claim 2, wherein within the reflection module, the reflection sheet contacts the support member.

4. The display device of claim 2, wherein the reflection module is further defined by the reflection sheet on the support member with an adhesion member therebetween.

5. The display device of claim 2, wherein within the reflection module, the support member comprises a metal.

6. The display device of claim 5, wherein the metal comprises stainless steel.

7. The display device of claim 2, wherein within the reflection module, the reflection sheet comprises a polymer material and has reflectance of about 95%.

8. The display device of claim 2, wherein the bottom chassis has a thickness of about 0.285 millimeter to about 0.315 millimeter.

9. The display device of claim 2, wherein a thickness of the bottom chassis is the same as a thickness of the reflection module defined by the reflection sheet on the support member.

10. The display device of claim 2, wherein the bottom chassis comprises aluminum or an electro-galvanized steel sheet.

11. The display device of claim 2, further comprising an adhesion member which couples the bottom chassis and the reflection module to each other.

12. The display device of claim 2, further comprising:
a first opening defined in the bottom chassis,
a second opening defined in the reflection module, the second opening corresponding to the first opening, and
a same one fixing member extendable into both the first opening and the second opening to couple the bottom chassis and the reflection module to each other.

13. The display device of claim 2, wherein the backlight unit further comprises a light guide member which guides light received from the light source, to the display panel.

14. The display device of claim 13, wherein the light guide member of the backlight unit contacts the reflection sheet of the reflection module.

15. A display device comprising:
a display panel;
a bottom chassis which faces the display panel and has a thickness of about 0.285 millimeter to about 0.315 millimeter;
a backlight unit comprising a light source and a light guide member which guides light received from the light source to the display panel, each of the light source and the light guide member disposed between the bottom chassis having the thickness of about 0.285 millimeter to about 0.315 millimeter and the display panel;
a reflection module defined by a reflection sheet which has a thickness of about 0.095 millimeter to about 0.15 millimeter and is disposed on a support member having a thickness of about 0.19 millimeter to about 0.21 millimeter, each of the reflection sheet and the support member disposed between the bottom chassis having the thickness of about 0.285 millimeter to about 0.315 millimeter and the display panel,
wherein the reflection sheet of the reflection module contacts the light guide member of the backlight unit.

16. The display device of claim 15, wherein within the reflection module, the reflection sheet contacts the support member.

17. The display device of claim 15, wherein the reflection module is further defined by the reflection sheet on the support member with an adhesion member therebetween.

18. The display device of claim 15, wherein within the reflection module, the support member comprises stainless steel.

19. The display device of claim 15, wherein within the reflection module, the reflection sheet comprises a polymer material and has reflectance of about 95%.

20. The display device of claim 15, further comprising an adhesion member which couples the bottom chassis and the reflection module to each other and has a thickness of about 0.095 millimeter to about 0.15 millimeter.
